(19) United States
(12) Patent Application Publication
(10) Pub. No.: US 2026/0342242 A1
(43) Pub. Date: Oct. 29, 2026

(54) ELECTROSTATIC GENERATOR

(71) Applicant: Jerry Semer, Fremont, OH (US)

(72) Inventor: Jerry Semer, Fremont, OH (US)

(21) Appl. No.: 19/155,489

(22) PCT Filed: Feb. 12, 2024
(86) PCT No.: PCT/US24/15339

§ 371 Date: Aug. 11, 2025

Related U.S. Application Data
(60) Provisional application No. 63/444,975, filed on Feb. 12, 2023.
(60) Provisional application No. 63/454,085, filed on Mar. 23, 2023.

(51) Int. Cl. H02N 1/06

(52) U.S. Cl. CPC H02N 1/06

(57) ABSTRACT

A generator system can include a first collector configured to collect ions of a given charge, either positive or negative and an ion creator configured to create ions near the first collector. The generator system can also include a charge collection circuit connected to the first collector to collect electricity flowing along the first collector and a means to create a static field positioned to direct the ions of the given charge toward the collector. The generator system can include a second collector configured to collect ions of the charge opposite the first collector, a second collection circuit connected to the second collector to collect electricity flowing along the second collector, and a second means to create a static field of a charge opposite the charge of the first means to create a static field.

### CROSS-REFERENCE TO RELATED APPLICATIONS

This application claims the benefit of U.S. Provisional Patent Application Ser. No. 63/444,975, filed on Feb. 12, 2023, and U.S. Provisional Patent Application Ser. No. 63/454,085, filed on Mar. 23, 2023. The entire disclosures of the above applications are hereby incorporated herein by reference.

### FIELD

The present technology includes processes and articles of manufacture that relate to the field of electrostatic generators and, more particularly, to the field of electrostatic generators that use an electrostatic field to move charges.

### INTRODUCTION

This section provides background information related to the present disclosure which is not necessarily prior art.

The invention is a method for producing energy from electrodes or antennas, electromagnetic fields, and ions. There are three primary ways charged particles move. Charged particles move along the lines of force of an electromagnetic field. Electrons move in a conductor from the negative side to the positive side. Charged particles can also move by a mechanical force, like being blown in the wind. A changing electrostatic field can also create current.

The Earth can work as both a sink and a source of electrons. When a conductor that is charged with electrons is connected to the Earth, the electrons will flow to the Earth. When a positively charged conductor is connected to the Earth, the electron will flow up from the Earth to neutralize the positive charge.

Experiments have shown that an electric field surrounds the Earth. The Earth's surface and the ionosphere form a large capacitor. In ‘fine weather,’ the potential, aka ‘voltage,’ increases with altitude at about 30 volts per foot (100 V/m) when climbing against the gradient of the electric field. This electric field gradient continues into the atmosphere to a point where the voltage reaches its maximum, in the neighborhood of 400,000 volts. This occurs at approximately 30-50 km above the Earth's surface.

When two dissimilar metal plates are stacked and separated by an air gap, an electric field equal to the difference in work function between the two metals will appear between the two surfaces. Ions within the area between will move towards one of the two plates due to the electrostatic field.

The typical embodiment in the prior art of an electrostatic generator is to use a wire stretched out vertically or horizontally. The wire is hooked to the ground. Electrons from the ground will neutralize positive ions in the air that make contact with the wire. The ions are driven towards the wire by the static field of the Earth, as pointed out above, and by the wind. The system's voltage is determined by how far the wire is above the ground.

To produce an electrostatic generator, one needs a static field, ions, and a collector grounded to the Earth or a capacitor. The Earth, or the capacitor, is a sink for charged particles. As a sink, the Earth or a capacitor can produce electrons to neutralize positive ions or collect electrons. A simple electrostatic generator of this nature would be a wire attached through a capacitor to the ground. Positive ions in the air would be attracted to the wire, and electrons from the ground would neutralize the positive ion that makes contact with the wire.

Any source that produces ions due to the conservation of charge must produce an equal number of positive and negative charged ions. Thus, the electrostatic generator must be able to neutralize positive and negative ions through a sink.

There are many ways known in the art to create a static field. The most common is an electret or a charged plate. Ions can also be created in many ways. Some common ways to produce ions in the air, vacuum, or dielectric surrounding the collector are radiation, electron impact ionization, corona, plasma discharge, a flame, cold cathode, thermionic emission, electrospray, strong external electric field emission, fast atom bombardment, electrospray ionization, atmospheric pressure chemical ionization, matrix-assisted laser desorption ionization, etc. Ions can also be created within the collector. The most common ways are radiation, thermionic emission, and the photoelectric effect.

One of the significant ways to produce ions is through radiation. Radiation can produce ions in two ways: collisions and heat. Radiation can produce ions far away from the its source. Thus, the sun, which is far from the Earth, produces radiation that can produce ions on Earth through the photoelectric effect or collisions. The sun's radiation could also heat a body and produce ions by thermionic effect. Cosmic rays from outer space can produce ions through collisions with air molecules.

The static field of the electrets or charge plates is designed to move the ions toward the collector. Since ion sources create ions that are both positive and negative, special care must be taken in the placement of the ion source, electrets or charged plates, and the collector such that ions of the opposite charge as the electrets or charged plates do not in substantial number end up accumulating on the electrets or charged plates thus hinder the system and reducing efficiency.

Accordingly, there is a need to improve the efficiency of electrostatic generators.

### SUMMARY

In concordance with the instant disclosure, a way to improve the efficiency of electrostatic generators, is surprisingly discovered.

In the certain embodiments, a generator system can include four components. The first component is a first collector configured to collect ions of a given charge, either positive or negative. The second component is an ion creator configured to create ions near the first collector. The next component is a charge collection circuit connected to the first collector and configured to collect electricity flowing along the first collector. The final component is a means to create a static field positioned to direct the ions of the given charge toward the first collector.

In certain embodiments, the generator system can include a second collector configured to collect ions of the charge opposite the ion collected by the first collector and a second collection circuit connected to the second collector and configured to collect electricity flowing along the second collector. The generator system can also include a second means to create a static field of a charge opposite the charge of the first means to create a static field.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a side view of the embodiment containing one electrode, with the ion source outside the electrode.

FIG. 1A is a side view of the embodiment containing one electrode, with the ion source being part of the electrode.

FIG. 2 is a side view of the embodiment containing two electrodes, with the ion source outside the electrodes.

FIG. 2A is a side view of the embodiment containing two electrodes, with the ion source being part of the top electrode.

FIG. 2B is a side view of the embodiment containing two electrodes, with the ion creator being part of the bottom electrode.

FIG. 2C is a side view of the embodiment containing two electrodes in a different configuration from FIG. 2.

FIG. 2D is a side view of the embodiment containing two electrodes in the same configuration as FIG. 2C with the ion creator being part of the bottom electrode.

FIG. 3 is a side view of the embodiment surrounded by a solid dielectric with the means of producing the static field being electret.

FIG. 3A is a side view of the embodiment surrounded by a solid dielectric with the means of producing the ion source being a charged plate.

FIG. 3B is a side view of the embodiment surrounded by a gas dielectric.

FIG. 3C is a side view of the embodiment surrounded by a liquid dielectric.

FIG. 4 is a side view of the embodiment containing an array of electrodes, with the ion creator outside the electrode.

FIG. 4A is a side view of the embodiment containing an array of electrodes, with the ion creator being part of the electrode.

FIG. 5 is a top view of the embodiment containing an array of wire electrodes.

FIG. 5A is a top view of the embodiment containing an array of plate electrodes.

FIG. 6 is a side view of the embodiment containing two arrays of electrodes, with the ion creator outside the electrodes.

FIG. 6A is a side view of the embodiment containing two arrays of electrodes, with the ion creator being part of the top electrode.

FIG. 7 is a side view of the embodiment surrounded by a solid dielectric with the means of producing the static field being electret, and ions are created within the dielectric by a radiation source outside the dielectric.

FIG. 7A is a side view of the embodiment surrounded by a solid dielectric with the means of producing the static field being a charged plate, and ions are created within the dielectric by a radiation source outside the dielectric.

FIG. 8 is an embodiment of the invention that uses a static field to accelerate a charged drop of liquid in which the inductor is an electret.

FIG. 8A is an embodiment of the invention that uses a static field to accelerate a charged drop of liquid in which the inductor is a charged plate.

FIG. 9 is a diagram of a shape of electrode 1.

FIG. 9A is a diagram of another shape of electrode 1.

FIG. 9B is a diagram of another shape of electrode 1.

FIG. 9C is a diagram of another shape of electrode 1.

FIG. 10 is a diagram of a shape of electrode 7.

FIG. 10A is a diagram of another shape of electrode 7.

FIG. 10B is a diagram of another shape of electrode 7.

FIG. 10C is a diagram of another shape of electrode 7.

FIG. 11 is a diagram of capacitor load 55.

FIG. 12 is a diagram for another embodiment of capacitor load 55.

FIG. 13 is a diagram of an electrostatic motor that can be attached across the output of some of the embodiments.

FIG. 13A is a diagram of a heater that can be attached across the output of some of the embodiments.

FIG. 14 is a diagram of the grounded capacitor load 57.

FIG. 15 is a diagram for another embodiment of the ground capacitor load 57.

FIG. 16 is a diagram of the circuit of collector loads 14 and 54, which consist of an electrostatic motor.

FIG. 16A is a diagram of the circuit of collector loads 14 and 54, which consists of a heater.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

All documents, including patents, patent applications, and scientific literature cited in this detailed description are incorporated herein by reference, unless otherwise expressly indicated. Where any conflict or ambiguity may exist between a document incorporated by reference and this detailed description, the present detailed description controls.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 110, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

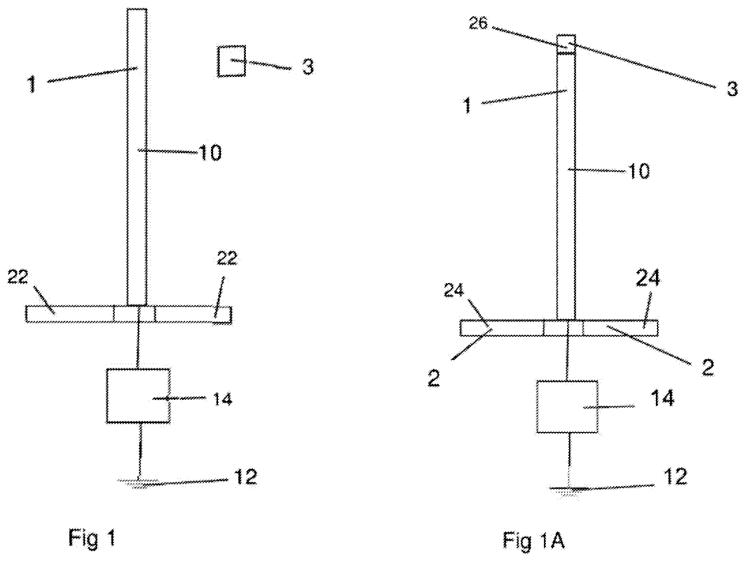

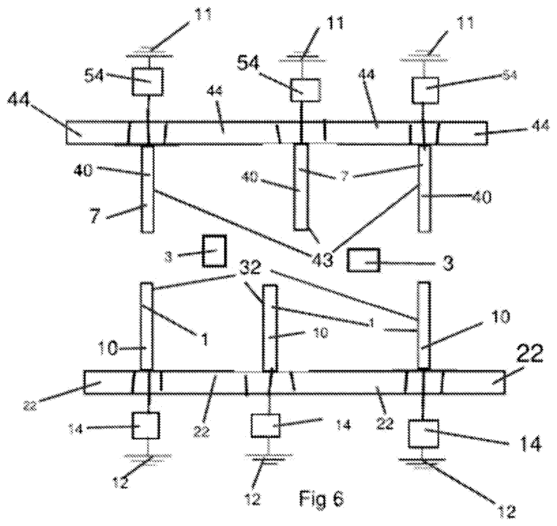

FIGS. 1 and 1A show electrostatic generators according to certain embodiments. FIGS. 1 and 1A show a collector 1, a means to produce a static field 2, an ion creator 3, and a collector load 14, which is attached electrically to a sink, usually a ground 12. In FIGS. 1 and 1A, collector 1 in the preferred embodiment is an electrode 10. Electrode 10 is a wire. The collector 1 in all the embodiments could be other shapes. Collector 1 can be pointed, several points oriented in any direction, a plate oriented in any direction, several plates oriented in any direction, a metalized balloon, or several balloons. FIGS. 9, 9A, 9B, and 9C show four more shapes that collector 1 could take. FIG. 9 shows collector 1 configuration with four points. FIG. 9A shows collector 1 configuration with one point. FIG. 9B shows collector 1 configured as a metalized sphere. FIG. 9C shows collector 1 as a plate.

Electrode 10 is attached to ground 12 through collector load 14. The means to create a static field 2 is usually produced by electret 22 in FIG. 1 or a charged plate 24 in FIG. 1A.

In FIG. 1, the ion creator 3 lies outside collector 1. In FIG. 1A, the ion creator 3 is on collector 1. The ion creator can produce ions itself or produce radiation that produces ions. Some common ways to produce ions in the air, vacuum, or dielectric surrounding the collector are radiation, electron impact ionization, corona, plasma discharge, a flame, cold cathode, thermionic emission, electrospray, strong external electric field emission, fast atom bombardment, electrospray ionization, atmospheric pressure chemical ionization, matrix-assisted laser desorption ionization, etc. Ions can also be created within the collector. The most common ways are radiation, thermionic emission, and the photoelectric effect.

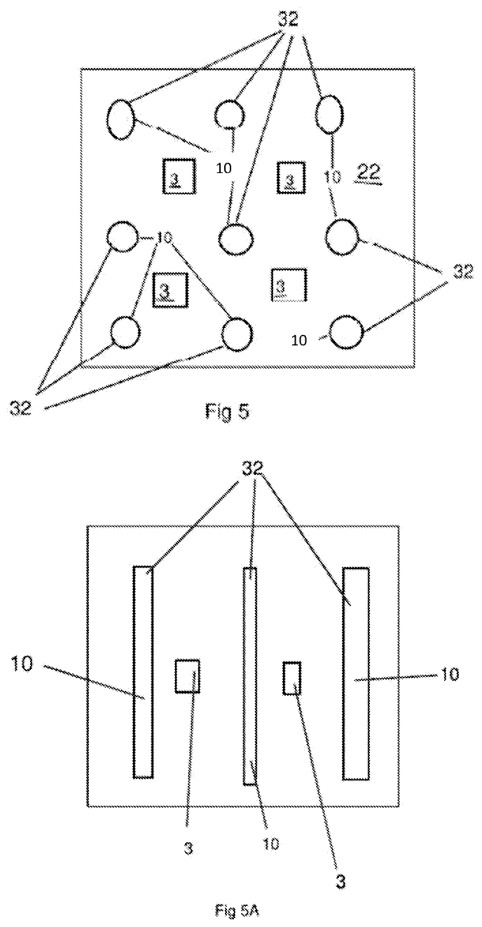

Radiation, such as an electromagnetic wave, or an accelerated particle, such as an alpha or beta particle, can create ions. Radiation can produce these ions by collision or heating the cell's dielectric. Radiation can produce ions far away from the radiation's source. The ion created by the ion creator 3, the collector 1, and the means to produce the static field 2 must be placed so that the static field will drive the ions created by the ion creator 3 to the collector 1 and the collector 1 and the means for producing the static field 2 must be designed to move electron either from the ground or to the ground to neutralize the charge created on the collector 1 by the ions. In FIGS. 1 and 1A, the means for producing a static field 2 is placed at the bottom of collector 1. However, the means for producing the static field 2 can be placed anywhere around collector 1. In FIG. 8, the ion creator 3 is above the mean for creating the static field 2, and the ions fall through the means for creating the static field 2, and collector 1 is below the means for creating the static field 2. There are numerous configurations in which the collector 1, means for producing the static field 2, the ion creator 3, and where the ions are created can be placed. However, the place where the ions are created by the ion creator 3, the collector 1, and the means to produce the static field 2 must be placed so that the static field will drive the ions from the place where the ion creator 3 creates the ions to the collector 1, and the collector 1 and the static field 2 must be designed to move electron either from the ground or to the ground to neutralize the charge created on the collector 1 by the ions. Electrostatic fields of conductors, electret, and ions can be calculated using Poisson and Laplace equations. Thus, the position of the ion creator 3, collector 1, can be engineered so that the ions from the ion creator 3 will move to collector 1 and further to the sink, which is usually the ground 12. As put forth above, ion creator 3 creates positive and negative ions. Special care must be taken in the placement of the ion creator 3, electrets 22 or charged plates 24, and the collector 1 such that ions of the opposite charge as the electrets 22 or charged plates 24 do not in substantial number end up accumulating on the electrets 22 or charged plates 24 thus hinder the system and reducing efficiency.

In FIG. 1A, the ion creator 3 is a beta emitter 26 attached to electrode 10. The beta emitter 26 is attached to the top of electrode 10. Around electrode 10 near the bottom is charged plate 24. In these embodiments, the electret 22 or the charged plate 24 has a negative charge. When the beta emitter 26 radiates electrons, it becomes more positive, drawing up electrons from ground 25. The electrons from ground 12 move through collector load 14 and up electrode 10 to neutralize the positive charge.

If FIGS. 1 and 1A are surrounded by air, some of the ions given off may obtain sufficient energy and collide with air molecules, and produce ion pairs. In the preferred embodiment shown in FIG. 1A, the negatively charged ions would be repelled by the negatively charged electret 22 or charged plate 24, and the positively charged ions would be attracted to the electrode 10 due to the static field created by the negatively charged electret 22 or the charged plate 24 and the electrode 10. Some ions created by the collisions may gain sufficient energy from the static field and collide with air molecules producing more ion pairs. When the positively charged ions of the ion pairs make contact with electrode 10, they make the electrode more positive and draw up electrons from the ground 12. The electrons from ground 25 move through collector load 14 and up electrode 10 to neutralize the positive charge.

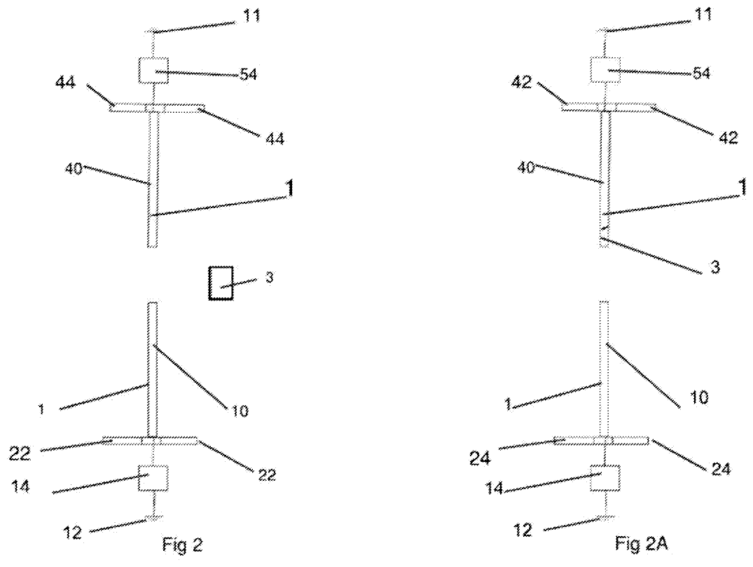

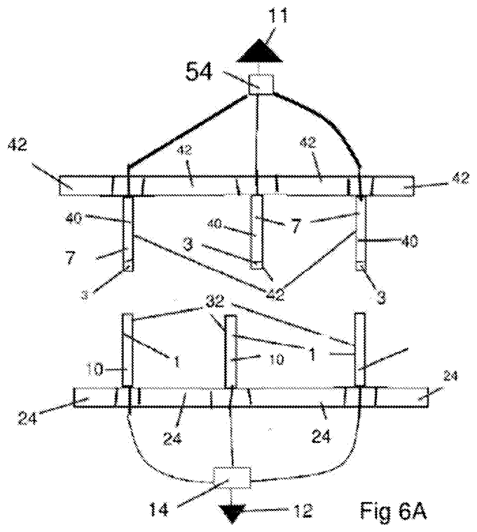

In the above configurations, the ions repelled by collector 1 are not collected by the generator and dissipate in the air. However, these could be collected and turned into energy. There are many ways that this can be accomplished. FIGS. 2 and 2A show an embodiment of the invention that collects these ions. Instead of having just one collector 1, FIGS. 2 and 2A have two collectors, 1 and 7. In FIGS. 2 and 2A, collector 1 in the preferred embodiment is an electrode 10. Collector 7 is electrode 40. Electrode 10 and 40 are wires. As in the previous embodiments, collectors 1 and 7 can be pointed, several points oriented in any direction, a plate oriented in any direction, several plates oriented in any direction, a metalized balloon, or several balloons. FIGS. 10, 10A, 10B, and 10C show four more shapes that collector 7 could take.

Electrode 40 is located above electrode 10. In the preferred embodiment above, electrode 40 is located below charged plate 42, shown in FIG. 2A, or an electret 44, shown in FIG. 2. The charged plate 42 in FIG. 2A and electret 44 in FIG. 2 are of the opposite charge of electret 22 in FIG. 2 and charged plate 24 in FIG. 2A beneath electrode 10. The charged plate 42 of FIG. 2A and the electret 44 of FIG. 2 have the opposite charge as electrode 10 and attract the ions repelled by electrode 10. In the preferred embodiment, electret 22 in FIG. 2 and charged plate 24 in FIG. 2A lie below electrode 10. Electret 40 in FIG. 2 and charged plate 44 in FIG. 2A are above electrode 40. The ion creator 3 is between electrodes 10 and 40, as shown in FIG. 2, or at the tip of either electrodes 10 or 40, as shown in FIGS. 2A and 2B. However, electrodes 10 and 40, electret 22 and 44, charged plates 42 and 24, and the ions from ion creator 3 can take numerous configurations. The ions form ion creator 3, and the collector electrodes 10 and 40 must be placed so that the static field created by electret 22 and 44 or charged plates 24 and 42 will drive the ions from the ion creator 3 to electrodes 10 and 40. The electrodes 10 and 40 must be positioned so that the ions that make contact with the electrodes 10 and 40 will attract or conduct electrons to or from the ground. The electrodes 10 and 40 must be placed to attract ions of opposite charge. Electrode 10 is attached to ground 12 through collector load 14. Electrode 40 is attached to ground 12 through collector load 54.

The embodiments of FIGS. 2, 2A, and 2B are surrounded by air. Some ions created by the ion creator may obtain sufficient energy and collide with air molecules, and produce ion pairs. The ions in the ion pairs produced could also gain sufficient energy from the static field and collide with other molecules in the air, and produce more ion pairs. In the preferred embodiment shown in FIGS. 2, 2A, and 2B, the negatively charged ions would be repelled by the negatively charged electret 22 or charged plate 24 and be attracted to electrode 40 due to the static field created by the positively charged electret 44 or the charged plate 42 and electrode 40. The positively charged ions would be attracted to electrode 10 due to the static field created by the negatively charged electret 22 or the charged plate 24 and electrode 10. When the positively charged ions contact electrode 10, they make electrode 10 more positive and draw up electrons from ground 12. When the negatively charged ions make contact with electrode 40, they make the electrode more negative and conduct electrons to the ground 12.

FIGS. 2C and 2D show another embodiment of the invention that collects the ions repelled by collector 1. Instead of having just one collector 1, FIGS. 2 and 2A have two collectors, 1 and 19. In FIGS. 2C and 2D, collector 1 in the preferred embodiment is an electrode 10. Collector 19 is electrode 15. Electrodes 10 and 15 could be a plate or a wire. Electrode 15 is located above electrode 10. The ion source 3, the collector electrodes 10 and 15 must be placed so that the static field created by electret 22 or charged plates 24 will drive the ions from the ion source 3 to electrodes 10 and 15. The electrodes 10 and 15 must be positioned so that the ions that make contact with the electrodes 10 and 15 will attract or conduct electrons to or from the ground. The electrodes 10 and 15 must be placed to attract ions of opposite charge. Electrode 10 is attached to ground 12 through collector load 14. Electrode 15 is attached to ground 12 through collector load 54.

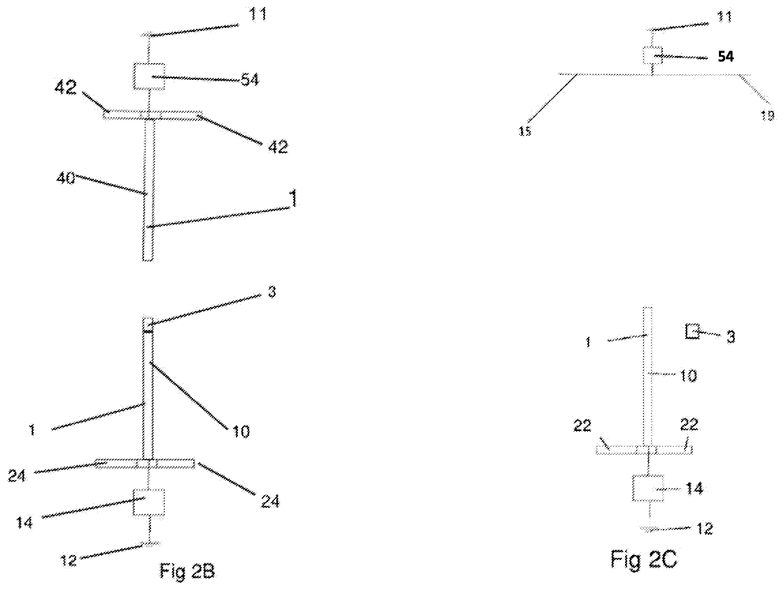

FIGS. 3, 3A, 3B, and 3C are like the embodiment of FIGS. 2 and 2A, except the generator is housed in dielectric 30, which is not air. The dielectric can be a gas, liquid, or solid. The embodiment of FIGS. 3, 3A, 3B, and 3C is within a defined area 70. If the dielectric is a gas or liquid, the defined area would be box 72, as shown in FIGS. 3B and 3C. The dielectric could also be a solid 73, which fills the space between the two electrets 22 and 44, as in FIG. 3, or two charged plates, as in FIGS. 3A and 3B. A common dielectric for filling the defined area 70 could be a semiconductor such as silicone. FIG. 3 shows a solid dielectric 73 filling the defined area 70. FIG. 3C shows a dielectric that is a liquid dielectric 71 within box 72. FIG. 3B shows a dielectric that is a gas dielectric 75 within box 72. As in FIGS. 3 and 3A, electrode 40 is above electrode 10. In the preferred embodiment above electrode 40 is a positively charged plate 42, shown in FIG. 3A, or a positive electret 44, shown in FIG. 3. In the preferred embodiment, negative electret 22 in FIG. 3 and negatively charged plate 24 in FIG. 3A lie below electrode 10, and positive electret 42 in FIG. 3 and positive charged plate 44 in FIG. 3A are above electrode 40. In FIGS. 3, 3A, and 3B, the ion creator lies outside electrodes 10 and 40. In FIG. 3C, the ion creator is at the tip of electrode 40. However, electrodes 10 and 40, electret 22 and 44, charged plates 42 and 24, and the ion creator 3 can take numerous configurations. The ion creator 3, collector electrodes 10 and 40 must be placed so that the static field created by electret 22 and 44 or charged plates 24 and 42 will drive the ions from the ion creator 3 to electrodes 10 and 40. The electrodes 10 and 40 must be positioned so that the ions that make contact with the electrodes 10 and 40 will cause electrons to flow to or up from the ground. The electrodes 10 and 40 must be placed to attract ions of opposite charge. Electrode 10 is attached to ground 12 through collector load 14. Electrode 40 is attached to ground 12 through collector load 54.

The embodiment of FIGS. 3, 3A, 3B, and 3C is surrounded by dielectric. Some ions in the static field may obtain sufficient energy and collide with molecules of the dielectric, and produce ion pairs. The ions in the ion pairs produced could also gain sufficient energy from the static field, collide with other dielectric molecules, and produce more ion pairs. In the preferred embodiment shown in FIGS. 3, 3A, 3B, and 3C, the negatively charged ions would be repelled by the negatively charged electret 22 or charged plate 24 and be attracted to electrode 40 due to the static field created by the positively charged electret 44 or the charged plate 42 and electrode 40. The positively charged ions would be attracted to electrode 10 due to the static field created by the negatively charged electret 22 or the charged plate 24 and electrode 10. When the positively charged ions make contact with electrode 10, they make the electrode more positive and draw up electrons from the ground 12. When the negatively charged ions make contact with electrode 40, they make the electrode more negative and conduct electrons to the ground 12.

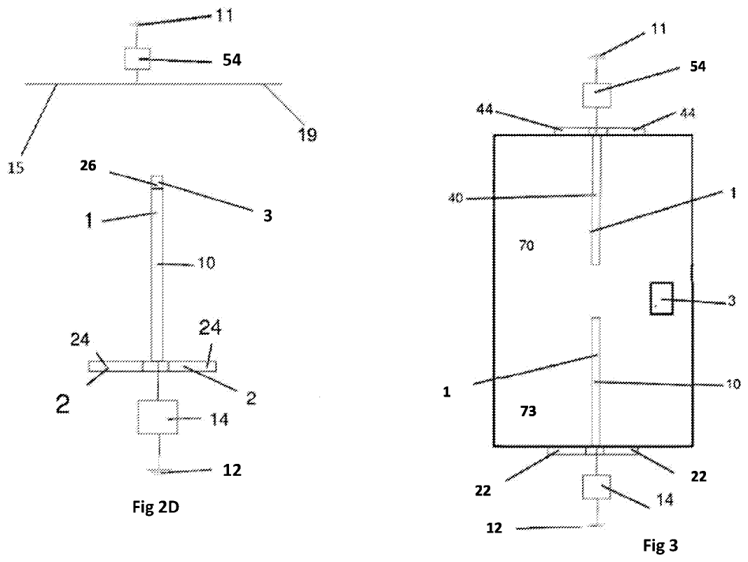

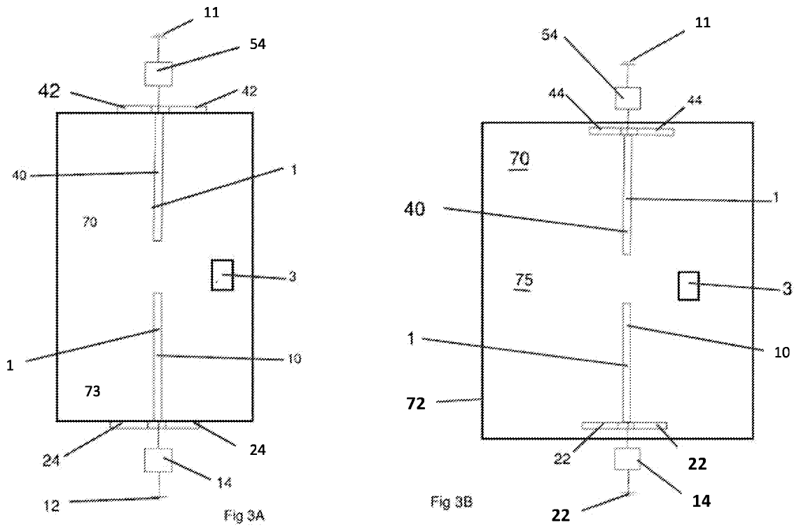

FIGS. 4, 4A, 5, and 5A show another embodiment of the invention. Collector 1, instead of having one electrode, FIGS. 4, 4A, 5, and 5A show collector 1 as an array of electrodes 32. In FIGS. 4, 4A, 5, and 5A, the array of electrode 32 is an array of wires. FIG. 5 A shows the array of electrodes 32 as an array of plates. As in the previous embodiments, the array of electrodes 32 can be other shapes. The electrode of the array of electrode 32 can be pointed, several points oriented in any direction, a plate oriented in any direction, several plates oriented in any direction, a metalized balloon, or several balloons. FIGS. 9, 9A, 9B, and 9C show four more shapes that the electrodes of the array of electrodes 32 could take.

Beneath the array of electrodes 32 is the electrets 22 or charge plate 24. FIG. 4 also shows that each electrode 10 of the array of electrodes 32 is attached to ground 12. FIG. 4 also shows ion creator 3 above the array of electrodes 32. In FIG. 4A, the ion creator 3 is at the tip of the electrodes in the array of electrodes 32. Ion creator 3 is positioned so that most of the ions produced by ion creator 3 will be attracted by the electret 22 or charge plate 24. The ion creator 3, the array of electrodes 32, and the electret 22 or charged plate 24 must be placed so that the static field will drive the ions from the ion creator 3 to the collector array of electrodes 32 and the array of electrodes 32 must be positioned that the ions that make contact with the array of electrodes 32 will cause electrons to flow to or up from the ground.

FIG. 4 also shows that each electrode 10 of the array of electrodes 32 is attached to ground 12 through a collector load 14. FIG. 4 shows each electrode in the array of electrodes 32 attached to its separate collector load 14 and ground 12. FIG. 4A shows all the electrodes in the array of electrodes 32 attached to ground 12 through one collector load 14.

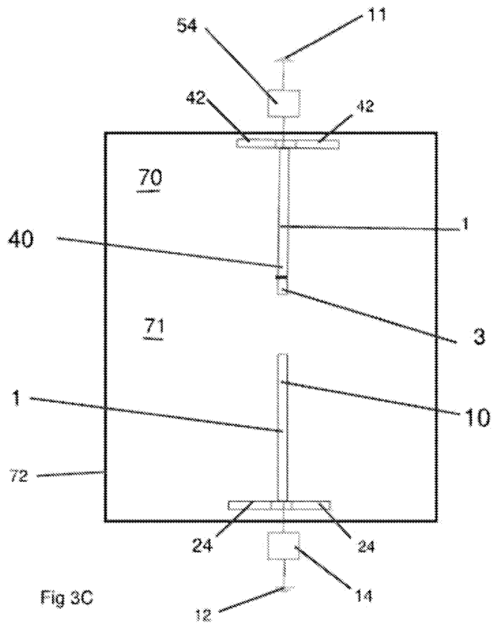

FIG. 6 and FIG. 6A show another embodiment of the invention. Instead of having just one array, FIGS. 6 and 6A show a second array of electrodes 40. Collector 1 has an array of electrodes 32, and collector 7 has an array of electrodes 43. As in a previous embodiment, the array of electrodes 32 is an array of wires, and the array of electrodes 43 is an array of wires. As in the previous embodiments, the array of electrodes 32 and 43 can be other shapes. The electrodes of the array of electrodes 32 and 43 can be pointed, several points oriented in any direction, a plate oriented in any direction, several plates oriented in any direction, a metalized balloon, or several balloons. FIGS. 9, 9A, 9B, 9C, 10, 10A, 10B, and 10C show four more shapes that the electrodes of the array of electrodes 32 and 43 could take.

As in the previous embodiment, beneath the array of electrodes 32 is electrets 22 or charge plate 24. The array of electrode 43 is located above the array of electrode 32. In the preferred embodiment above electrode 43 is a charged plate 42 shown in FIG. 6 A or an electret 44 in FIG. 6. The charged plate 42 and the electret 44 are of the opposite charge than the electret 22 and charged plate 24 beneath array of electrode 32. The charged plate 42 and the electret 44 are of the opposite charge as the array of electrode 32 and attract the ions repelled by the array of electrode 32. In the preferred embodiment, electret 22 and charged plate 24 lie below the array of electrode 32 and electret 44 and charged plate 42 are above the array of electrode 43, and the ion creator 3 is between the array of electrodes 32 and 43 as shown in FIG. 6 or at the end of either electrodes 10 or 40 as shown in FIGS. 6A and 6B. However, the array of electrodes 32 and 43, electret 22 and 44, charged plates 42 and 24, and the ion creator 3 can take numerous configurations. The ion source 3, the array of electrodes 32 and 43, must be placed so that the static field created by electret 22 and 44 or chanrged plates 24 and 42 will drive the ions from the ion creator 3 to the array of electrodes 32 and 43 and the array of electrodes 32 and 43 must be positioned that the ions that make contact with the array of electrodes 32 and 43 will flow to ground 12. The array of electrodes 32 and 43 must be placed to attract ions of opposite charge.

FIG. 6 also shows that the array of electrodes 32 is attached to ground 12 through a collector load 14. FIG. 6 shows each electrode in the arrays of electrodes 32 attached to its separate collector load 14 and ground 12 and each electrode in the arrays of electrodes 43 attached to its separate collector load 54 and ground 12. FIG. 6A shows all the electrodes in the array of electrodes 32 attached to one collector load 14 and ground 12 and all the electrodes in the array of electrodes 43 attached to ground 12 through one collector load 54.

FIG. 6 also shows ion source 3. In this embodiment, ion source 3 produces ion pairs. An ion pair is two ions of different charges. One ion is positive, and one ion is negative. Ion source 3 is positioned so that most of the ions produced by ion creator 3 will be propelled by the means to produce the static field 2, electret 22 and 44, and charged plates 24 and 42. The ion creator 3, the array of electrodes 32 and 43, and the electrets 22 and 44 or charged plates 24 and 42 must be placed so that the static field will drive the ions from the ion creator 3 to the collector array of electrodes 32 and 43 and the array of electrodes 32 and 43 must be positioned that the ions that make contact with the array of electrodes 32 and 43 will cause electrons to flow to or up from the ground.

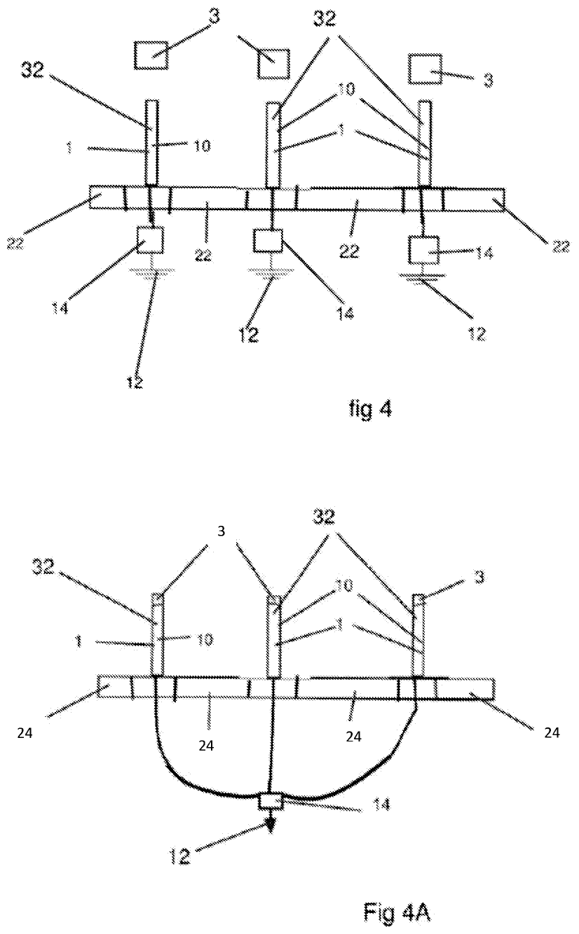

Ions can be created by radiation, such as an electromagnetic wave, or an accelerated particle, such as an alpha or beta particle. Radiation can produce these ions by collision or heating the cell's dielectric. Radiation can produce ions far away from the radiation's source. FIG. 7 shows an embodiment where radiation from outside the electrostatic generator produces ions within the electrostatic generator. FIG. 7 is like the embodiment of FIGS. 2 and 3, except the ions are created within the dielectric by a radiation source outside the dielectric. The dielectric can be a gas, liquid, or solid. If the dielectric is a gas or liquid dielectric 77, the defined area would be box 72, as shown in FIG. 7A. The embodiment of FIGS. 7 and 7A is placed within the defined area 70, filled with a dielectric. A common dielectric for filling the defined area 70 could be a semiconductor such as silicone. In semiconductors such as silicone, the pairs of charged particles created are usually not referred to as ion pairs but as electrons and holes. FIG. 7 shows a solid dielectric 74, which fills the defined area 70. Waves or particles 78 from a radiation source 76 outside the defined area 70 penetrate the defined area and produce ion pairs within the defined area 70. In the preferred embodiment, the positive ions are attracted to electrode 10, and the negative ions are attracted to electrode 40. Electrode 40 is located above electrode 10. In the preferred embodiment above, electrode 40 is located below positively charged plate 42, shown in FIG. 7A, or a positive electret 44, shown in FIG. 7. In the preferred embodiment, negative electret 22 in FIG. 7 and negatively charged plate 24 in FIG. 7A lie below electrode 10, and positive electret 42 in FIG. 7 and positive charged plate 44 in FIG. 7A are above electrode 40. However, electrodes 10 and 40, electret 22 and 44, and charged plates 42 and 24 can take numerous configurations. The electrodes 10 and 40 must be placed so that the static field created by electret 22 and 44 or charged plates 24 and 42 will drive the ions created by the waves and particles 78 to electrodes 10 and 40. The electrodes 10 and 40 must be positioned so that the ions that make contact with electrodes 10 and 40 will flow to ground 12. The electrodes 10 and 40 must be placed to attract ions of opposite charge. Electrode 10 is attached to ground 12 through collector load 14. Electrode 40 is attached to ground 12 through collector load 54. Radiation from outside the cell could also produce ions within the cell for other configurations shown in FIGS. 1, 2, 4, and 6.

Liquid droplets can also be charged. There are many methods known in the art of charging liquid droplets. Electrospray is a process of electrostatically charging liquid droplets used in many scientific and industrial processes. Once these droplets are charged, a static field can accelerate the droplets.

FIG. 8 shows an embodiment of this principle. FIG. 8 shows an electrostatic generator based on charged liquid drops. In FIG. 8, the liquid could be water. FIG. 8 shows a liquid container 100 at the top of the embodiment. A small opening in the bottom of the liquid container 100 allows a stream of liquid 104 to flow from the liquid container 100. The stream of liquid 104 changes from a stream to a set of individual droplets 106. At the point where the stream of liquid 104 changes to a set of individual droplets 106, an inductor tube 108 is placed. The inner surface of the inductor tube 108 is charged. This can be done by making the inner surface an electret or a charged plate. In FIG. 8, the inner surface of inductor tube 108 is an electret 118, and in FIG. 8A, the inner surface is a charged plate 122. A short distance under the inductor tube 108 is the means for producing a static field 3. In FIG. 8, the means for producing a static field 3 is an electret 118. The charge on the inner surface of inductor tube 108 must be the opposite of the charge on the means for producing the static field 3. Beneath the means for producing the static field 3 is a collector 130 for collecting the liquid drops 106. Collector 110 is attached to ground 12 through collector load 14. The liquid in the liquid container 100 is grounded by a wire 124. The wire 124 runs from within the liquid to ground 12. The wire 124 is attached to ground 12 through collector load 54.

The liquid in the liquid container 100 flows through a small opening at the bottom of the liquid container 100. The liquid falls into inductor tube 108. The inductor tube 108 has a charge on its inner surface that repels the ions of the same charge in the liquid stream 104, leaving the ions of the opposite charge at the end of the stream of liquid 104. The end of the stream of liquid 104 breaks off into liquid droplets 106 with the opposite charge as the inner wall of the inductor tube 108. The liquid droplets fall through an opening electret 118. The electret 118 on its bottom side is charged with the same charge as the individual droplet 106. Thus, the static field of the electret 118 will accelerate the individual droplet 106 towards the collector 110.

The ions in the stream of liquid 104 that are repelled upward towards the liquid container 100 will make the liquid in the liquid container 100 more charged and thus will decrease the efficiency of the inductor tube 108 charging the individual droplets 106. To decrease this inefficiency, the wire 124 is placed in the liquid in the liquid container 100 and ran to ground 12.

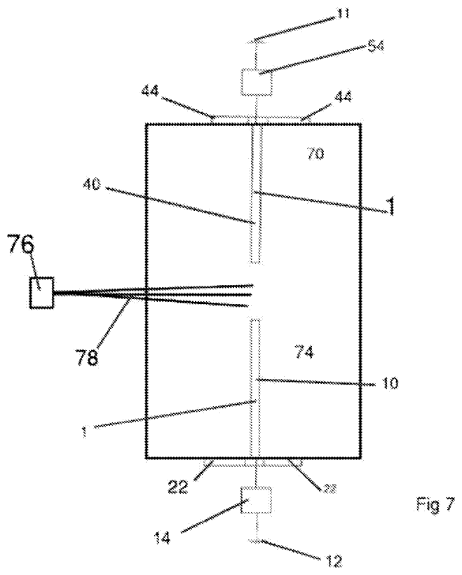

The electrostatic generator of this invention can be designed without the need for a ground. In FIGS. 2, 2A, 2B, 3, 3A. 6, 6A, 7, 7A, 8, and 8A, the wires running to collector loads 14 and 54 could be attached to capacitor load 55. Capacitor load 55, shown in FIG. 11, is a capacitor150 and a circuit 152 that discharges the capacitor 150 at a specific voltage and runs the discharged energy through load 154. Circuit 152 can be created by many circuits known in the art. These include high-voltage relay circuits, spark gap circuits, thyratron circuits, high-voltage switching tube circuits, and many others.

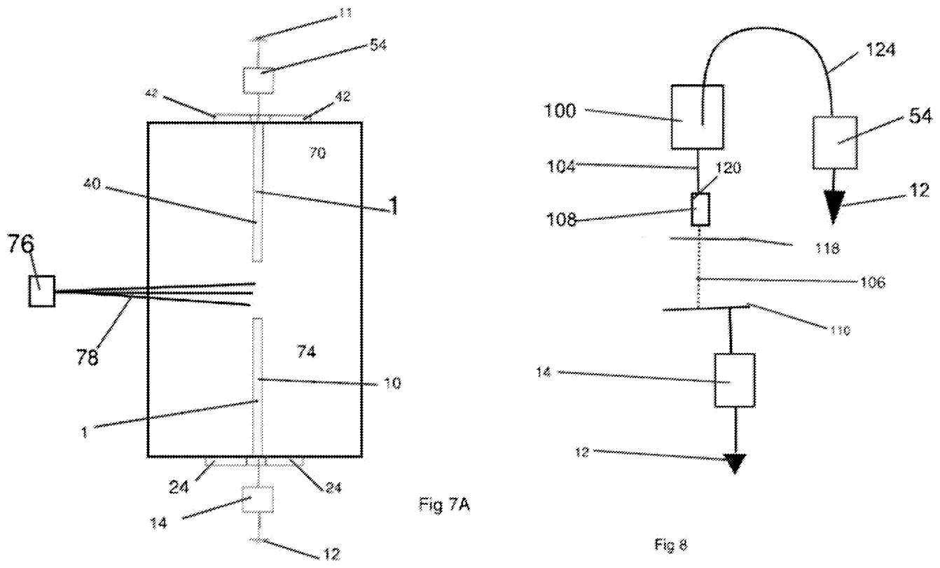

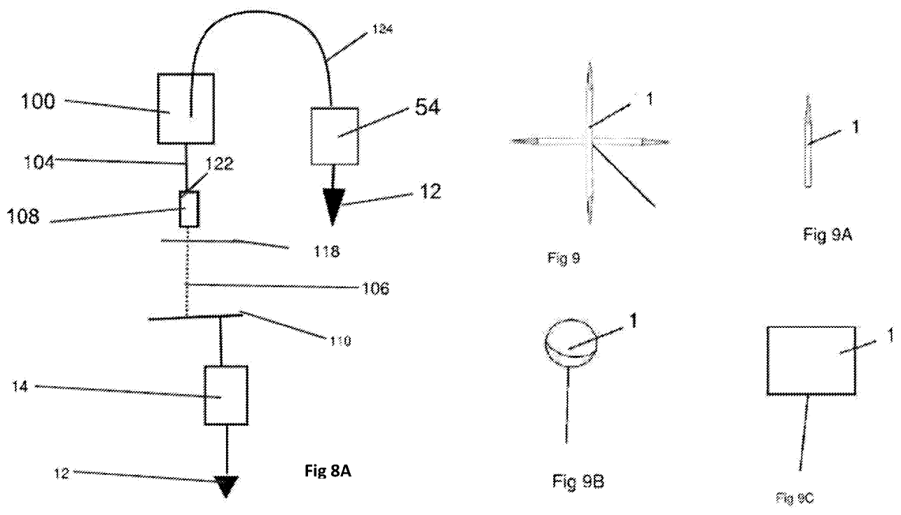

FIG. 12 represents the capacitor load 55 configured to collect electricity flowing along collectors 1 and 7. The capacitor load 55 may be a charge collection circuit characterized by capacitance 631, inductance 632, and resistance 633. The electricity may be collected by charging a capacitor associated with capacitance 631. In this diagram, battery 610 represents the voltage gradient between the wires running to capacitor load 55. Collectors 1 and 7 can, for the purpose of analysis and optimization of the charge collection process, be viewed as electromagnetic transmission lines characterized by their effective capacitance, inductance, and resistance per unit length. Accordingly, the parameters of the charge collection circuit and the effective transmission line representing collectors 1 and 7 are optimized to maximize the net charge and energy collected.

In FIGS. 2, 2A, 2B, 3, 3A. 6, 6A, 7, 7A, 8, and 8A, the wires running to collector loads 14 and 54 could be attached to a load such as an electrostatic motor 200 or a heater 210, as shown in 13 and 13A.

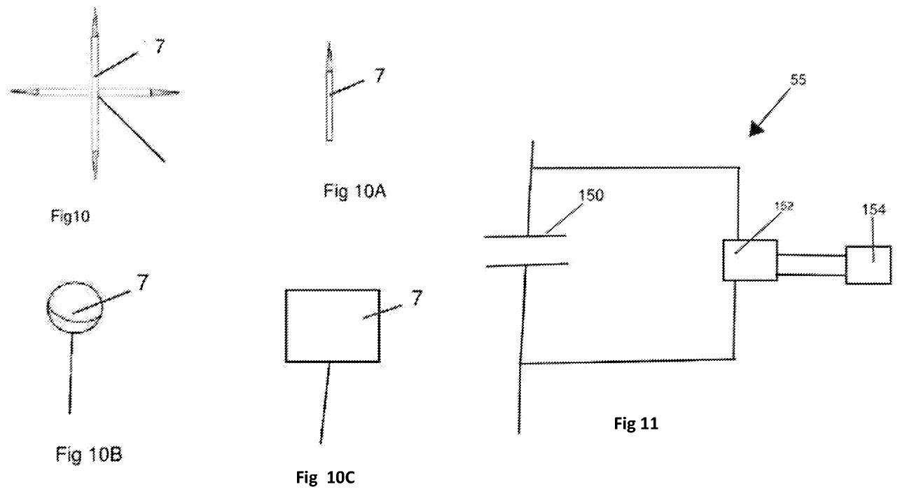

The circuit of collector load 14 and 54 could be a ground capacitor load 57. Grounded capacitor load 57, shown in FIG. 14, is similar to capacitor load 56 except that it is attached to ground 12. Grounded capacitor load 57 is a capacitor 150 and a circuit 152 that discharges the capacitor 150 at a specific voltage and runs the discharged energy through load 154 and to ground 12. Circuit 152 can be created by many circuits known in the art. These include high-voltage relay circuits, spark gap circuits, thyratron circuits, high-voltage switching tube circuits, and many others.

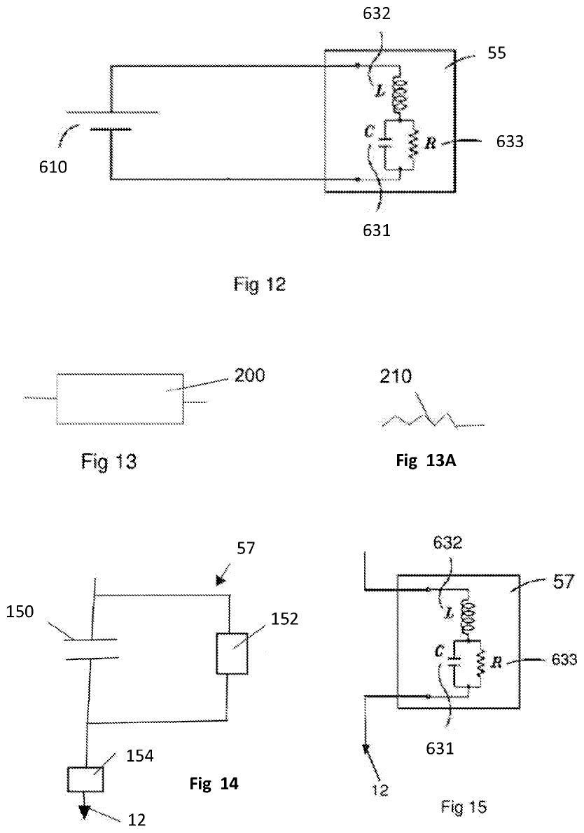

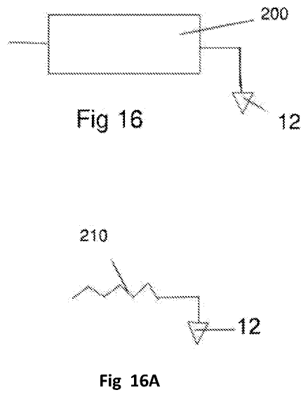

FIG. 15 represents the grounded capacitor load 57 to collect electricity flowing along collectors 1 or 7. The grounded capacitor load 57 may be a charge collection circuit characterized by capacitance 631, inductance 632, and load or resistance 633. The electricity to be collected by charging a capacitor is associated with capacitance 631 from the charge on collector 1 or 7. Collectors 1 or 7 can, for the purpose of analysis and optimization of the charge collection process, be viewed as electromagnetic transmission lines characterized by their effective capacitance, inductance, and resistance per unit length. Accordingly, the parameters of the charge collection circuit and the effective transmission line representing collectors 1 and 7 are optimized to maximize the net charge and energy collected.

The preceding description enables a person skilled in the art to practice the various configurations described herein. While the subject technology has been particularly described with reference to the various figures and configurations, it should be understood that these are for illustration purposes only and should not be taken as limiting the scope of the Subject technology.

There may be many other ways to implement the Subject technology. Various functions and elements described herein may be partitioned differently from those shown without departing from the scope of the Subject technology. Various modifications to these configurations will be readily apparent to those skilled in the art, and generic principles defined herein may be applied to other configurations. Thus, many changes and modifications may be made to the Subject technology by one having ordinary skill in the art without departing from the scope of the Subject technology.

A phrase Such as an “embodiment does not imply that such embodiment is essential to the Subject technology or that such embodiment applies to all configurations of the subject technology. A disclosure relating to an embodiment may apply to all embodiments or one or more embodiments. An embodiment may provide one or more examples of the disclosure. A phrase such as ”embodiment“ may refer to one or more embodiments and vice versa. A phrase Such as a ”configuration“ does not imply that such configuration is essential to the Subject technology or that Such configuration applies to all configurations of the Subject technology. A disclosure relating to a configuration may apply to all configurations or one or more configurations. A configuration may provide one or more examples of the disclosure. A phrase Such as a ”configuration′ may refer to one or more configurations and vice versa.

A reference to an element in the singular is not intended to mean “one and only one unless specifically stated, but rather “one or more.” The term “some’ refers to one or more.

All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public, regardless of whether such disclosure is explicitly recited in the above description.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

1-42. (canceled)

43. A generator system comprising:
a given charge collector that collects ions of a given charge, either positive or negative;
a given charge collection circuit connected to the given charge collector that collects electric flowing along the given charge collector;
an oppositely charge collector that collects ions of an opposite charge as the given charge collector;
an oppositely charge collection circuit connected to the oppositely charge collector that collects electric flowing along the oppositely charge collector;
an ion source configured to create ions within either one or both of the given and oppositely charge collectors or create ions in a vicinity of the generator system; and
a static field positioned to accelerate ions of the given charge towards the given charge collector and ions of the opposite charge towards the oppositely charge collector and to cause electricity to flow along the given and oppositely charge collectors to eliminate ions within the given and oppositely charge collectors and cause electricity to flow into or out of the given and oppositely charge collection circuits.

44. The generator system of claim 43, wherein the static field is created by a charged material.

45. The generator system of claim 44, wherein the charged material is of both the given charge and the opposite charge.

46. The generator system of claim 45, wherein the given charge collector is below the oppositely charge collector, and the charged material of the opposite charge is below the given charge collector.

47. The generator system of claim 45, wherein the charged material is an electret or a charged plate.

48. The generator system of claim 43, further comprising a solid, a liquid, or a gas disposed between the given charge collector and the oppositely charge collector.

49. The generator system of claim 48, wherein the solid or liquid is a semiconductor.

50. The generator system of claim 43, further comprising a vacuum disposed between the given charge collector and the oppositely charge collector.

51. The generator system of claim 43, wherein the ion source creates ions through radiation.

52. A generator system comprising:
an array of given charge collectors that collect ions of a given charge, either positive or negative;
an ion source configured to create ions within the array of given charge collectors or create ions in a vicinity of the array of given charge collectors;
a given charge collection circuit connected to all of the given charge collectors within the array of given charge collectors, that collects electric flowing along the given charge collectors; and
a static field positioned to accelerate ions of the given charge towards the array of given charge collectors and to cause electricity to flow along the array of given charge collectors to eliminate ions of the given charge within the array of given charge collectors and cause electricity to flow into or out of the given charge collection circuit.

53. The generator system of claim 52, wherein the static field is created by a charged material.

54. The generator system of claim 53, wherein the array of the given charge collectors is above the charged material.

55. The generator system of claim 53, wherein the charged material is an electret or charged plate.

56. The generator system of claim 52, wherein the ion source creates ions through radiation.

57. The generator system of claim 52, further comprising:
an array of oppositely charged collectors that collects ions of an opposite charge as the array of the given charge collectors; and
an oppositely charge collection circuit connected to all of oppositely charge collectors within the array of oppositely charged collectors that collects electric flowing along the oppositely charge collectors;
wherein the static field is positioned to accelerate ions of an opposite charge from the given charge towards the array of the oppositely charge collectors and to cause electricity to flow along the array of oppositely charged collectors to eliminate ions within the array of oppositely charge collectors and cause electricity to flow into or out of the oppositely charge collection circuit.

58. The generator system of claim 57, wherein the static field is created by a charged material.

59. The generator system of claim 58, wherein the charged material is of both the given charge and the opposite charge.

60. The generator system of claim 59, wherein the charged material is an electret or charged plate.

61. The generator system of claim 59, wherein the array of the given charge collector is below the array of the opposite charge collector, and the charged material of the opposite charge is below the array of given charge collectors.

62. The generator system of claim 57, further comprising a solid, liquid, or gas disposed between the array of the given charge collectors and the array of the oppositely charge collectors.

63. The generator system of claim 62, wherein the solid or liquid is a semiconductor.

64. The generator system of claim 57, wherein the ion source creates ions through radiation.

65. The generator system of claim 57, further comprising a vacuum between the array of the given charge collectors and the array of the oppositely charge collectors.

66. The generator system of claim 57, further comprising a second ion source configured to create ions within the array of oppositely charge collectors.
